(19) United States
(12) Patent Application Publication
(10) Pub. No.: US 2013/0285592 A1
(43) Pub. Date: Oct. 31, 2013

(54) MEDIUM VOLTAGE SOFT STARTER AND INDUCTION MOTOR KIT

(71) Applicants: James E. Johnson, Tampa, FL (US); Aleksandar B. Damjanovic, Oldsmar, FL (US)

(72) Inventors: James E. Johnson, Tampa, FL (US); Aleksandar B. Damjanovic, Oldsmar, FL (US)

(73) Assignee: PHASETRONICS, INC., Clearwater, FL (US)

(21) Appl. No.: 13/455,947

(22) Filed: Apr. 25, 2012

(51) Int. Cl. H02P 1/26

(52) U.S. Cl. 318/778

(57) ABSTRACT

The present invention includes an induction motor soft starter that includes a bypass contactor loop on which is disposed two anti-parallel connected SCRs and a current limiting reactor that limits the current rise during the switching on of the SCRs.

### FIELD OF THE INVENTION

The present invention relates in general to medium voltage soft starters for induction motors, and in particular, to a soft starter including a current limiting reactor.

### BACKGROUND

An induction motor is an AC motor where power is supplied to the rotor by means of electromagnetic induction. Such motors are widely used in industrial drives. The process of starting an induction motor can damage the motor and influence the characteristics of the electrical power system. This is especially true in medium voltage applications. If the motor is started with a significantly higher current than rated, mechanical and thermal stress can occur to the motor or loads. Large voltage fluctuations and deep sags can occur in the electrical power system associated with the motor starting. This problem has been addressed in part by solid state soft starters, in particular medium voltage solid state soft starters. Medium voltage solid state soft starters protect the motor from failure and excessive maintenance caused by mechanical shock during starting and stopping by providing smooth, stepless acceleration and controlled deceleration.

Many such soft starters include a silicon controlled rectifier (hereinafter “SCR”) to control current. Prior Art FIG. 1 shows a single line diagram of a basic configuration of soft starter 16. Soft starter 16 utilizes SCRs 8, bypass contactor 7, line isolation vacuum contactor 4, and motor starter output terminals 12, and is connected to a power system, including power grid 1, power cable 13 and induction motor 14.

Soft starter 16 also includes load break switch 2 with grounding bar 18, motor fuse 3, current transformer 5, low voltage control compartment 9, isolation transformer 10, and fiber optic cable 11. With the main attention in the design, development, and application of soft starters being on motor protection, pulsating torques, harmonics, and power system voltage sags and dips, no attention has been focused on protection of the SCR. The starting process can produce electrical transients in the form of current change events that are of major concern for the SCR. These events and their value are amplified by an increase in overall system capacitance and working voltage levels.

A system's capacitance has three origins. The first capacitance origin is power factor correction capacitors. This capacitance may be easily eliminated by switching off the capacitor during the motor starting. The second origin is static VAR compensators. These line input connected capacitors typically cannot be removed during motor starting, as in many instances they are in place to support a weak power feed. The third capacitance origin is the inherent capacitance of the soft starter and power system elements, such as the power cable, contactors, transformers, etc. These are unavoidable during motor starting. Even simple measures, such as increasing cable length or quantity can affect the capacitance value. A well known characteristic of a capacitor is that voltage across the capacitor cannot be changed instantaneously. When a voltage is applied to a capacitor, therefore, a large current tries to flow instantly into the capacitor to charge it to the value of the applied voltage. This rapid current change can be greater than the capability of the SCR, leading to its failure.

The solid state soft starter adds flexibility to the system because it can be adjusted to deliver an optimal starting current profile to the induction motor. This may result in lower maintenance costs and increased lifetime of the mechanical load, as well as improved energy efficiency. Starters including SCRs typically utilize anti-parallel, or back-to-back SCRs. Their switching signals are delayed from the voltage zero crossing so that the applied motor current is significantly lower than typical starting currents. After the motor reaches full speed, the SCRs are bypassed by a contactor.

To start the induction engine, the SCRs are switched on, and there is no control on the amount of current flowing through them. The current through the SCRs is entirely dictated by the external impedance connected in the circuit and the applied voltage. The maximum rate of increase in current during the SCR switching that the SCR can tolerate is called the critical rate of rise of current for the device. The critical rate of rise is specified at maximum junction temperature. During the first few microseconds of turning on, only a small area in the gate conducts the anode current. If the current increases too fast, localized overheating will occur and the SCRs may be permanently damaged.

Now referring to Prior Art FIGS. 2A-2C, transient currents during SCR switching on are shown. In these FIGS. 2A-2C, mV represent Amperes. The average current rise, ΔI/Δt, therefore is ΔmV/Δt. FIG. 2A highlights the current fluctuations with dotted circles. FIG. 2B shows an extreme case where the average current rise is 318A/μs. The common average current rise is 140-150A/μs. Such a typical scenario is shown in FIG. 2C with a current rise of 140.7A/μs. These current rises during the switching on period can damage the SCRs due to the inherent capacitance in the system. Although an SCR may withstand a current change rate of 200, or even 300A/μs on a one time basis, this is not the case for a practical application. Therefore there is a need for a solid state medium voltage soft starter that controls current rises to within limits that will not damage the starter's SCRs.

### SUMMARY OF THE INVENTION

The present invention includes a soft starter and an induction motor kit including the soft starter of the present invention.

In its most basic form, the soft starter of the present invention includes a basic soft starter configuration with an SCR and a current limiting reactor. The basic soft starter configuration uses anti-parallel SCRs and bypass and line isolation contactors, as shown in Prior Art FIG. 1. The soft starter of the present invention also includes a current limiting reactor. The current limiting reactor and its placement within the bypass contactor loop, before or after the SCRs is a means for reducing current rise during the switching on of the SCRs. The current limiting reactor may be disposed either before or after the SCRs, but within the bypass contactor loop, within the soft starter. By bypassing the SCRs and the reactor, it is not necessary to design the reactor for continuous duty at full rated current. This allows the reactor to be much smaller, which allows it to fit more easily into the soft starter's enclosure. It is preferred that the current limiting reactor be understacked relative to the SCRs.

The current limiting reactor of the present invention provides several additional advantages. The current limiting reactor only needs to be connected to the soft starter network for the starting of the SCRs. When understacked to the SCRs, the reactor provides mechanical support for the SCRs and also provides isolation for the heat sink, allowing for the elimination of epoxy resin standoffs that are typically employed. The SCRs used with the present invention are preferably part of a heat sink assembly for the soft starter, and the understacked reactor also provides support for this entire heat sink assembly. Finally, the relatively small size of the reactor allows it to be part of the larger soft starter enclosure so that the reactor does not require its own enclosure. This saves both space and money.

Through extensive research and analysis, practical field measurements, and general experience, the inventors of the present invention have concluded that to protect the SCRs in the soft starter, the current change should not exceed 75 A/μs. This parameter dictates a reactor inductance of 50-200 μH. The inductance may be higher or lower than this range, however. These determinations were formed in part by mathematical models and Electro Magnetic Transient Program (hereinafter “EMTP”) simulations of the soft starter in order to understand the nature of the transient processes and relevant parameters that influence it. Furthermore, analytical formulae are used for the calculation of transient current without EMTP stimulations and determination of the required inductance to limit the current rise to a safe level for SCRs. The relevant equation is as follows:

L_{R}=V_{P}/(ΔI/Δt)

Where:

L_{R} is the required inductance to limit current use in μH;

V_{P} is the system voltage peak in V; and

ΔI/Δt is the safe current rise for SCRs in A/μs.

In its most basic form, the induction motor kit of the present invention includes an induction motor integral to a soft starter as described above.

Therefore it is an aspect of the present invention to provide a soft starter that limits current rise during switching on so as to protect the soft starter's SCRs.

It is a further aspect of the present invention to provide a soft starter with lower maintenance and longer lifetime.

It is a further aspect of the present invention to provide a soft starter that includes a current limiting reactor with an inductance of 50-200 μH.

It is a further aspect of the present invention to provide a reactor that may be installed before or after the SCRs and inside the bypass contactor loop.

It is a further aspect of the present invention to provide a very small reactor that easily fits within the soft starter's enclosure.

It is a further aspect of the present invention to provide SCRs in combination with heat sinks for absorbing heat from the soft starter's operation.

It is a further aspect of the present invention to understack the current limiting reactor to the SCR/heat assembly to provide mechanical support for this assembly and to electrically isolate the heat sink.

It is a further aspect of the present invention to provide a current limiting reactor small enough to fit within the soft starter's enclosure.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a prior art diagram of a medium voltage solid state soft starter including anti-parallel SCRs.

FIG. 2A is a graph highlighting transient currents during SCR switching on.

FIG. 2B is a graph showing an extreme average current rise with a prior art soft starter.

FIG. 2C is a graph showing a typical average current rise with a prior art soft starter.

FIG. 3A is a diagram of a medium voltage solid state starter including anti-parallel SCRs and the current limiting reactor of the present invention before the SCRs.

FIG. 3B is a diagram of a medium voltage solid state starter including anti-parallel SCRs and the current limiting reactor of the present invention after the SCRs.

FIG. 4 is a graph showing an average current rise where the soft starter includes the current limiting reactor of the present invention.

FIG. 5 is a photograph of the preferred soft starter of the present invention.

### DETAILED DESCRIPTION

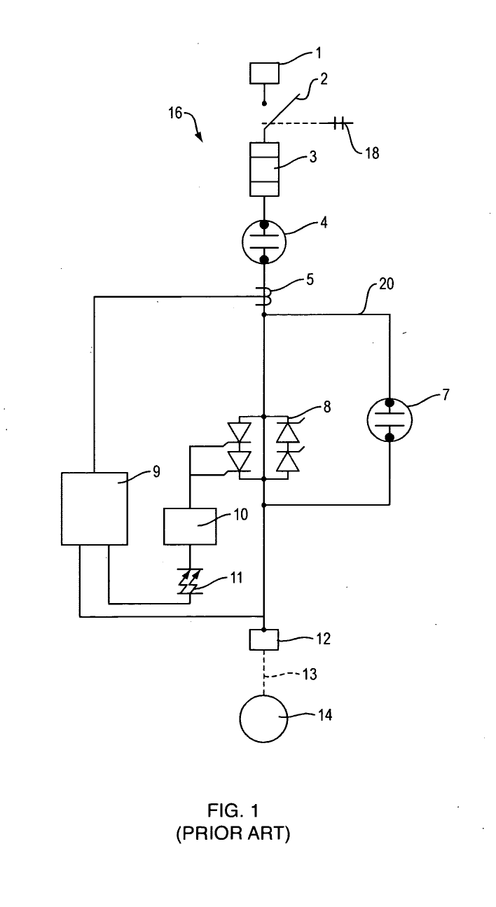

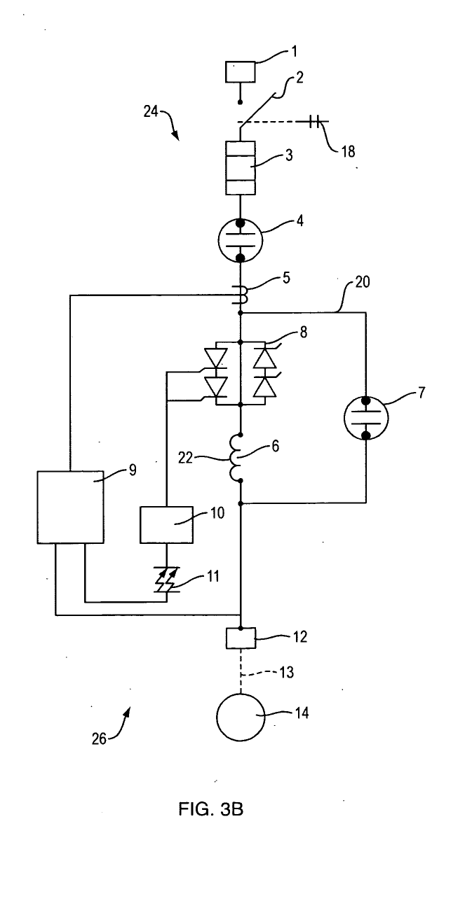

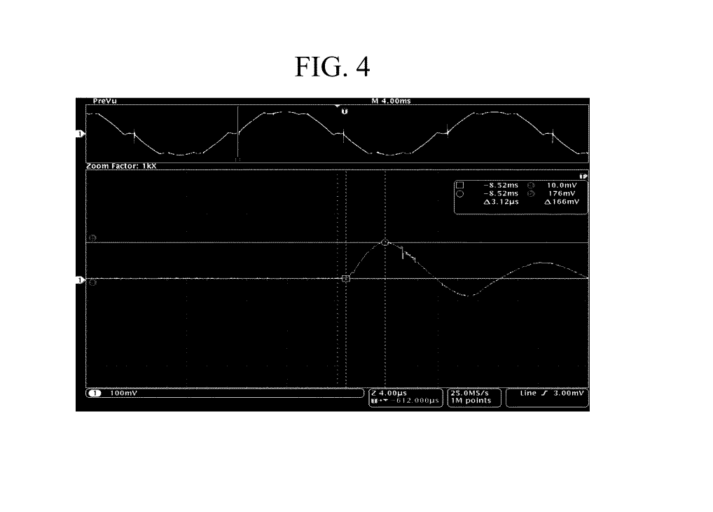

Referring first to FIGS. 3A and 3B, soft starter 24 of the present invention is shown. Soft starter 24 is a medium voltage solid state soft starter, and includes all of the features of prior art soft starter 16, as shown in FIG. 1, as well as current limiting reactor 6. In particular, soft starter 24 utilizes SCRs 8, bypass contactor 7, line isolation vacuum contactor 4, and motor starter output terminals 12, and is connected to a power system, including power grid 1, power cable 13 and induction motor 14. Soft starter 24 also includes load break switch 2 with grounding bar 18, motor fuse 3, current transformer 5, low voltage control compartment 9, isolation transformer 10, and fiber optic cable 11. Current limiting reactor 6 is disposed within bypass contactor loop 20, either before SCR 8, as shown in FIG. 3A, or after SCR 8, as shown in FIG. 3B. Current limiting reactor 6 is a means 22 for reducing current rise during the switching on of SCRs 8. FIGS. 3A and 3B also show kit 26 of the present invention, as they shown soft starter 24 integral to induction motor 14.

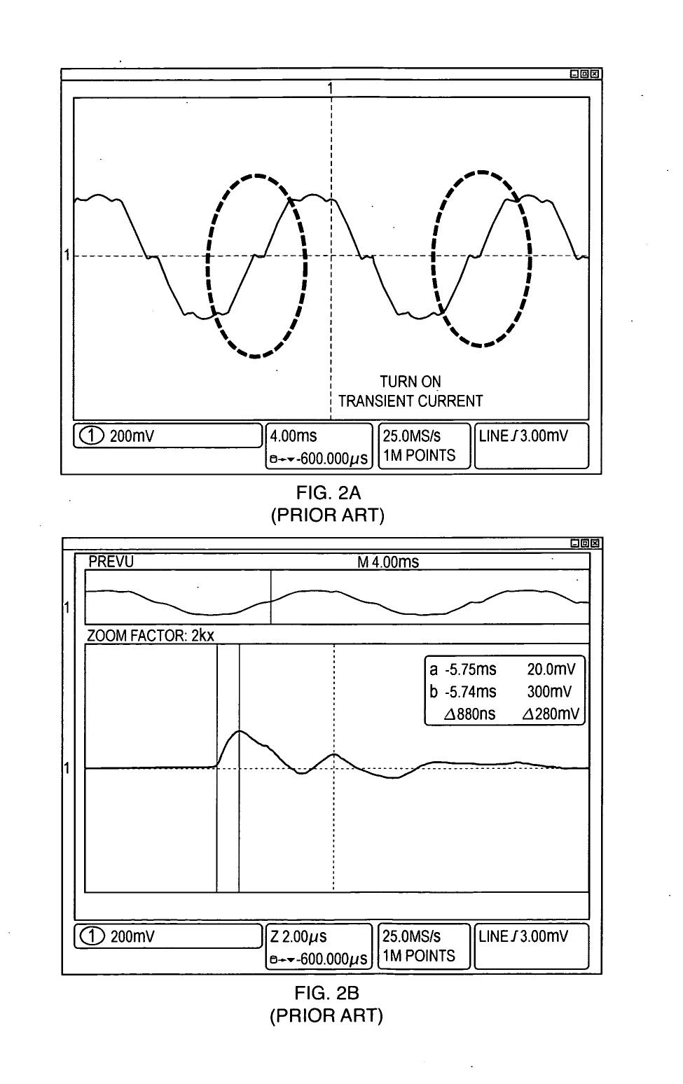

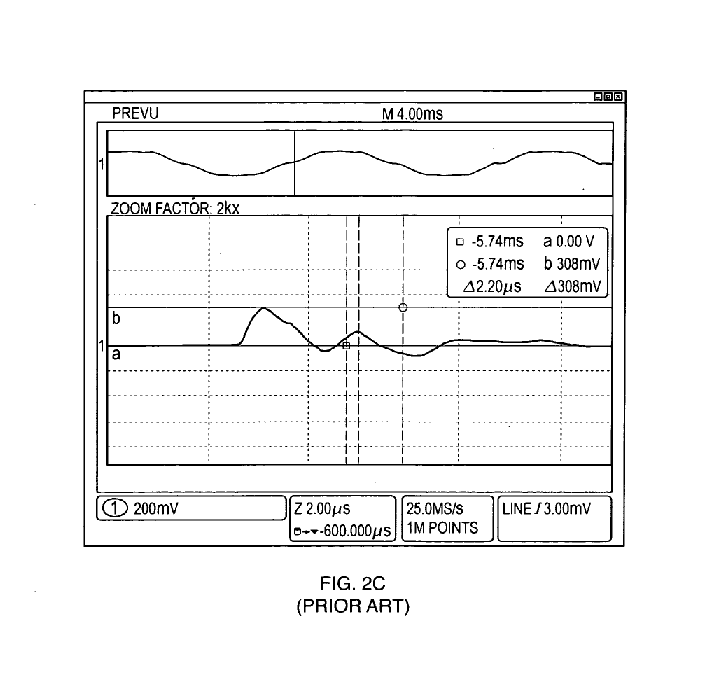

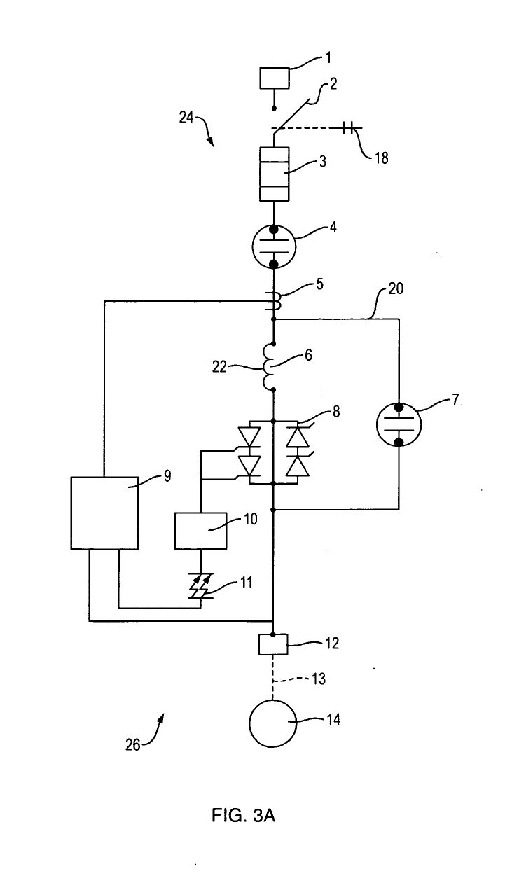

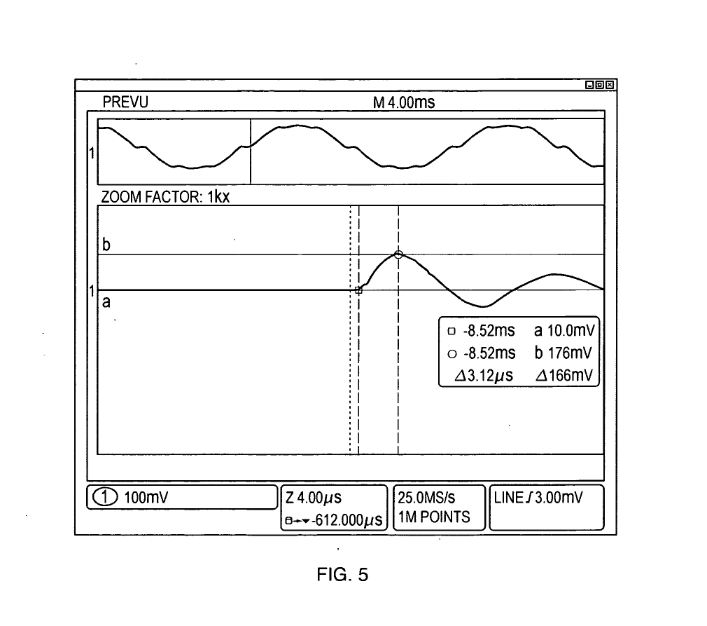

Now referring to FIG. 4, a graph is provided, showing an average current rise upon switching on of SCRs 8 of soft starter 24 of the present invention. Soft starter 24 includes current limiting reactor 6 with 100 μH inductance. The average current rise in this scenario is 53.2A/μs. This is significantly lower than either of the scenarios graphed in FIGS. 2B and 2C, 318A/μs and 140.7A/μs, respectively, with prior art soft starter 16 that does not include current limiting reactor 6. As the inventor's studies have shown that SCRs may be damaged with a current rise in excess of 75A/μs, FIGS. 2B, 2C, and 4 clearly indicate that prior art soft starter 16 may damage its SCRs 8 during switching on, while soft starter 24 of the present invention will not.

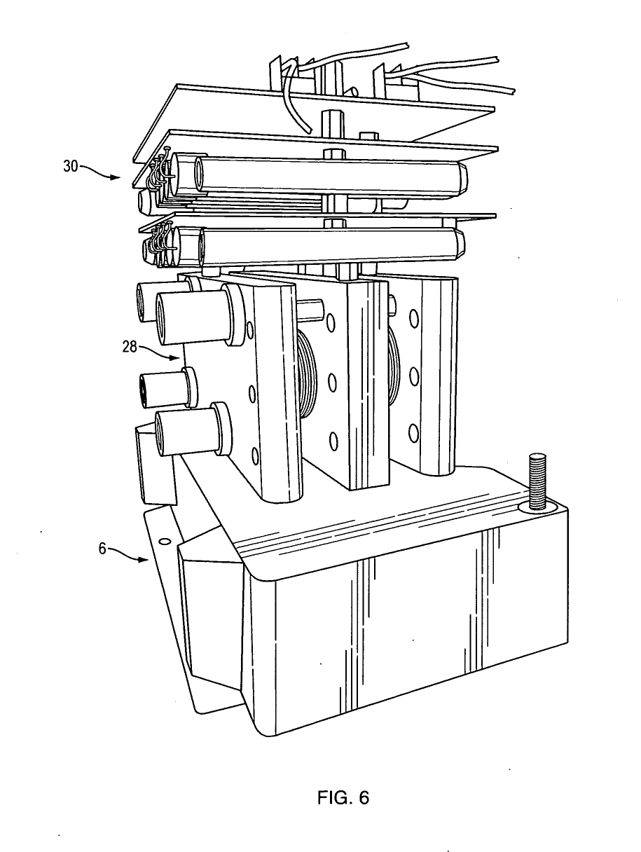

Now referring to FIG. 5, a photograph of the preferred soft starter configuration is shown. From top to bottom, included are circuit board assembly 30, SCR/heat sink assembly 28, and current limiting reactor 6. SCR/heat sink assembly 28 includes SCRs 8 discussed above in combination with heat sinks for absorbing heat from the soft starter's operation. This is a unique aspect of the present invention. Current limiting reactor 6 is understacked to SCR/heat sink assembly 28 to provide mechanical support for this feature.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A solid state medium voltage soft starter for use with an induction motor, said soft starter comprising:
a bypass contactor loop on which is disposed at least one SCR; and
a current limiting reactor that limits a current rise during a switching on of said at least one SCR.

2. The soft starter as claimed in claim 1, wherein said at least one SCR is two anti-parallel connected SCRs.

3. The soft starter as claimed in claim 1, wherein said current limiting reactor is disposed before said at least one SCR on said bypass contactor loop.

4. The soft starter as claimed in claim 1, wherein said current limiting reactor is disposed after said at least one SCR on said bypass contactor loop.

5. The soft starter as claimed in claim 1, further comprising an SCR/heat sink assembly comprising said at least one SCR;
wherein said SCR/heat sink assembly absorbs heat produced by operation of said soft starter; and
wherein said current limiting reactor is understacked to said SCR/heat sink assembly.

6. The soft starter as claimed in claim 5, wherein said at least one SCR is two anti-parallel connected SCRs.

7. The soft starter as claimed in claim 5, wherein said current limiting reactor is disposed before said at least one SCR on said bypass contactor loop.

8. The soft starter as claimed in claim 5, wherein said current limiting reactor is disposed after said at least one SCR on said bypass contactor loop.

9. The soft starter as claimed in claim 1, wherein said current limiting reactor comprises an inductance in a range between 50 μH and 200 μH.

10. The soft starter as claimed in claim 1, wherein said current limiting reactor limits the current rise during the switching on of said at least one SCR to no greater than 75A/μs.

11. The soft starter as claimed in claim 1, wherein said current limiting reactor is only electronically connected to said bypass contactor loop during said switching on of said at least one SCR.

12. The soft starter as claimed in claim 1, further comprising an enclosure surrounding said soft starter, and wherein said current limiting reactor is dimensioned to fit within said enclosure.

13. An induction motor kit comprising an induction motor and an induction motor soft starter for disposition in electrical communication with said induction motor, wherein said soft starter comprises:
an SCR/heat sink assembly comprising two anti-parallel connected SCRs, wherein said SCR/heat sink assembly absorbs heat produced by operation of said soft starter; and
a bypass contactor loop on which is disposed said SCR/heat sink assembly and a current limiting reactor that limits a current rise during a switching on of said SCRs, wherein said current limiting reactor is understacked to said SCR/heat sink assembly.

14. The induction motor kit as claimed in claim 13, wherein said current limiting reactor is disposed before said SCRs on said bypass contactor loop.

15. The induction motor kit as claimed in claim 13, wherein said current limiting reactor is disposed after said SCRs on said bypass contactor loop.

16. The induction motor kit as claimed in claim 13, wherein said current limiting reactor comprises an inductance in a range between 50 μH and 200 μH.

17. The induction motor kit as claimed in claim 13, wherein said current limiting reactor limits the current rise during the switching on of said SCRs to no greater than 75A/μs.

18. The induction motor kit as claimed in claim 13, wherein said current limiting reactor is only electronically connected to said bypass contactor loop during said switching on of said SCRs.

19. The induction motor kit as claimed in claim 13, further comprising an enclosure surrounding said soft starter, wherein said current limiting reactor is small enough to fit within said enclosure.
